(19) United States
(12) Patent Application Publication
(10) Pub. No.: US 2017/0277513 A1
(43) Pub. Date: Sep. 28, 2017

(54) VOICE INPUT SUPPORT METHOD AND DEVICE

(71) Applicant: FUJITSU LIMITED, Kawasaki-shi (JP)

(72) Inventor: Susumu Koga, Kawasaki (JP)

(73) Assignee: FUJITSU LIMITED, Kawasaki-shi (JP)

(21) Appl. No.: 15/453,930

(22) Filed: Mar. 9, 2017

(30) Foreign Application Priority Data
Mar. 23, 2016 (JP) 2016-058958

(51) Int. Cl. G06F 3/16; G10L 25/51; G10L 15/30; G10L 15/22

(52) U.S. Cl. CPC G06F 3/167; G10L 15/22; G10L 25/51; G10L 15/30; G10L 2015/223

(57) ABSTRACT

An information processing system includes circuitry configured to, acquire information identifying a plurality of voice commands associated with each of a plurality of screens to be displayed by a display, identify a first plurality of voice commands of the plurality of voice commands corresponding to a first screen, of the plurality of screens, currently displayed by the display, acquire first sound information captured by a microphone, compare the first sound information to first voice patterns associated with the first plurality of voice commands, and output a first result based on a first comparison between the first sound information to the first voice patterns.

### CROSS-REFERENCE TO RELATED APPLICATION

This application is based upon and claims the benefit of priority of the prior Japanese Patent Application No. 2016-058958, filed on Mar. 23, 2016, the entire contents of which are incorporated herein by reference.

### FIELD

The embodiments discussed herein are related to a technology of supporting input of voice.

### BACKGROUND

In recent years, an augmented reality (AR) technology in which, using a display device, such as a head mounted display or the like, an object is superimposed and thus displayed on a captured image has been proposed. For a case where a head mounted display is used, it has been proposed that a command input using voice recognition is used as an input method. Also, it has been proposed to, in order to manage moving picture data, store representative image data of moving pictures, a voice-recognized keyword, and moving image data in association with one another to thus manage indexes.

For example, Japanese Laid-open Patent Publication No. 08-212328, Japanese Laid-open Patent Publication No. 2010-034893, and Japanese Laid-open Patent Publication No. 2006-301757 discuss related art.

### SUMMARY

According to an aspect of the invention, an information processing system includes circuitry configured to, acquire information identifying a plurality of voice commands associated with each of a plurality of screens to be displayed by a display, identify a first plurality of voice commands of the plurality of voice commands corresponding to a first screen, of the plurality of screens, currently displayed by the display, acquire first sound information captured by a microphone, compare the first sound information to first voice patterns associated with the first plurality of voice commands, and output a first result based on a first comparison between the first sound information to the first voice patterns.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a voice input support system according to an embodiment;

FIG. 2 is a view illustrating an example of notification of filtering information;

FIG. 3 is a view illustrating an example of a filtering information storage section;

FIG. 4 is a view illustrating an example where there is a corresponding voice command;

FIG. 5 is a view illustrating an example where there is not a corresponding voice command;

FIG. 6 is a table illustrating an example of a voice command storage section;

FIG. 7 is a sequence diagram illustrating an example of voice input processing according to an embodiment;

FIG. 8 is a sequence diagram illustrating an example of voice input processing according to an embodiment; and

FIG. 9 is a diagram illustrating an example of a computer that executes a voice input support program.

### DESCRIPTION OF EMBODIMENTS

In one aspect, the present disclosure provides a voice input support program, a head mounted display, a voice input support method, and a voice input support device that are capable of increasing voice recognition accuracy.

Embodiments of a voice input support program, a head mounted display, a voice input support method, and a voice input support device disclosed herein will be described in detail below with reference to the accompanying drawings. Note that the technology disclosed herein is not limited to the specific embodiments illustrated herein. Also, embodiments described below may be combined, as appropriate, to the extent that there is no contradiction.

### Embodiments

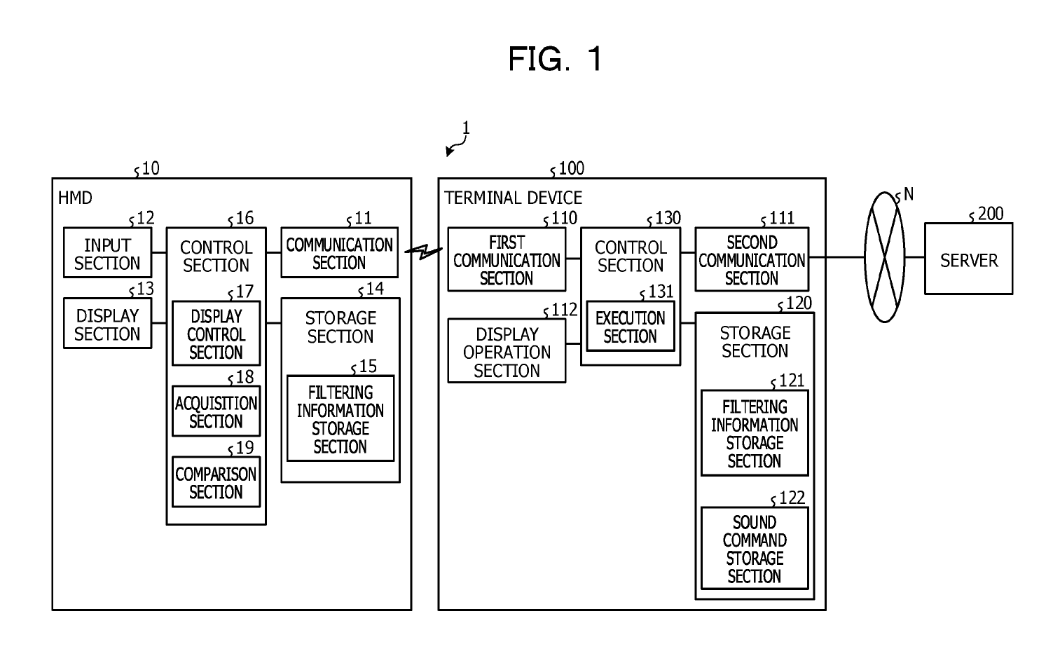

FIG. 1 is a block diagram illustrating an example of a configuration of a voice input support system according to an embodiment. A voice input support system 1 illustrated in FIG. 1 includes a head mounted display (HMD) 10, a terminal device 100, and a server 200. The HMD 10 and the terminal device 100 are coupled to one another in a one-to-one correspondence in a wired or wireless manner. That is, the HMD 10 functions as an example of a display section of the terminal device 100. Note that a connection between the HMD 10 and the terminal device 100 is not limited to a connection in a one-to-one correspondence but may be provided in a one-to-many, many-to-one, or many-to-many correspondence. Also, although, in FIG. 1, for a pair of the HMD 10 and the terminal device 100, one pair thereof has been described as an example, the number of pairs of the HMD 10 and the terminal device 100 is not limited to one but may be an arbitrary number. Also, the HMD 10 and the terminal device 100 are of an example of a voice input support device.

The HMD 10 and the terminal device 100 are coupled to one another, for example, via a wireless local area network (LAN), such as Wi-Fi Direct (registered trademark) or the like, so as to be mutually communicable with one another. Also, the terminal device 100 and the server 200 are coupled to one another via a network N so as to be mutually communicable with one another. As the network N, a communication network of an arbitrary type, such as the Internet, a LAN, a virtual private network (VPN), or the like, may be employed, whether the network N is a wired or wireless network.

A user wears the HMD 10 with the terminal device 100, and the HMD 10 displays a display screen transmitted from the terminal device 100. For example, a monocular transmission-type HMD may be used as the HMD 10. Note that, for example, each of various types of HMDs, such as a binocular HMD, an immersive HMD, or the like, may be used as the HMD 10. Also, the HMD 10 includes a microphone as an example of an input section in order to receive a voice input made by the user.

When the HMD 10 acquires sound information collected by the microphone, the HMD 10 refers to the storage section that stores a plurality of voice patterns in association with image information and acquires a voice pattern associated with image information displayed on a screen of a terminal. The HMD 10 compares the acquired sound information and the acquired voice pattern to one another and outputs a comparison result. When the output comparison result indicates that the sound information and the voice pattern match, the HMD 10 transmits a voice command ID (identifier) to the terminal device 100. Thus, the HMD 10 may increase voice recognition accuracy.

The terminal device 100 is an information processing device that the user wears to operate and, for example, as the terminal device 100, a mobile communication terminal, such as a tablet terminal, a smartphone, or the like, or the like may be used. The terminal device 100 executes, for example, an AR middle wear (which will be hereinafter also referred to as an “AR middle”) that operates in cooperation with the HMD 10 and a web application (which will be hereinafter also referred to as a “web app”). The AR middle provides a basic function, such as display of AR contents, screen transition in a display screen, an operation menu, or the like to the web app. The web app provides, for example, an operation screen related to equipment inspection or the like to the user. Note that, in the following description, the AR middle and the web app together are also referred to as an AR app. Also, when the AR middle and the web app are distinguished from one another, the AR middle and the web app are described as an “AR middle 100a” and a “web app 100b”.

The server 200 includes, for example, a database that manages the AR contents used for equipment inspection in a certain plant and a database that stores filtering information in each screen of a web app. Note that the filtering information is information in which a voice command ID is associated with a screen, that is, information in which a plurality of voice patterns is associated with image information. In response to a request from the terminal device 100, the server 200 transmits the AR contents to the terminal device 100 via the network N. Also, in response to a request from the terminal device 100, the server 200 transmits the filtering information to the terminal device 100.

In this case, input of a voice command using voice recognition according to the present disclosure is compared to input of a voice command using known voice recognition. In input of a voice command using known voice recognition, even when processing is not associated with a result of voice recognition, voice recognition is performed and, for example, a recognition sound is made to notify the user that voice recognition has been performed. In reality, however, in such a case, there is not a voice command that corresponds to the recognition result, and therefore, no processing is performed, so that the user is not able to know a voice recognition result or a processing result after voice recognition. In contrast, in input of a voice command using voice recognition according to the present disclosure, filtering information is used and, when processing is not associated with a result of voice recognition, filtering is performed, and thus, for example, a recognition sound is not made. Therefore, in input of a voice command using voice recognition according to the present disclosure, the user knows that it is not possible to use, on the current screen, a voice command that was input through voice input.

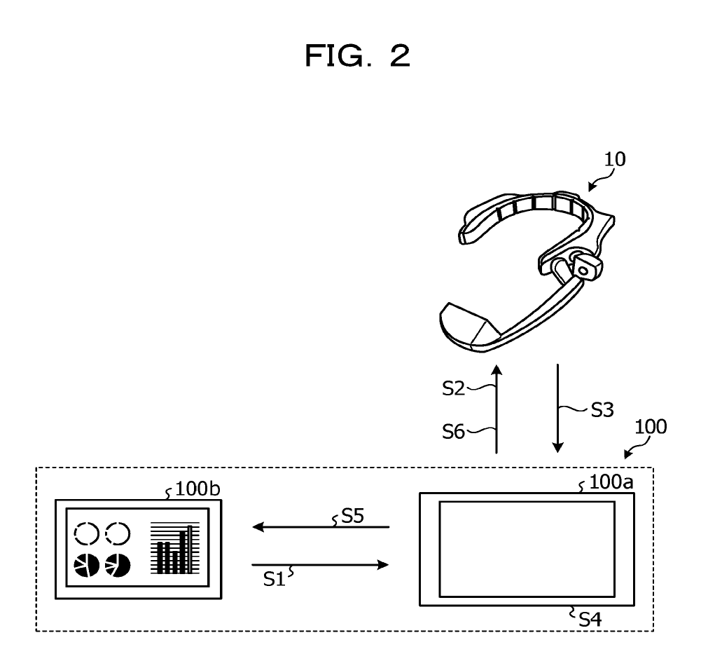

Notification of filtering information according to the present disclosure will be described. FIG. 2 is a view illustrating an example of notification of filtering information. Note that, in FIG. 2, an image of a display screen displayed on the HMD 10 is schematically illustrated in the web app 100b but, in reality, is displayed on a display element of the HMD 10. In the example of FIG. 2, a list of voice commands, that is, filtering information, used in the web app 100b is notified to the AR middle 100a from the web app 100b (Step S1). Next, the AR middle 100a transmits the filtering information that is used in the AR middle 100a and the web app 100b to the HMD 10 (Step S2). Also, the AR middle 100a transmits the screen ID of a screen that is being displayed to the HMD 10. The HMD 10 starts filtering in voice recognition, based on the filtering information that corresponds to the screen ID.

The HMD 10 performs voice command recognition on sound information input by the user and compares the sound information to a voice pattern included in the filtering information. When, as a result of the comparison, the sound information matches the sound pattern included in the filtering information, the HMD 10 transmits the voice command ID of a matching voice command to the AR middle 100a (Step S3).

The AR middle 100a executes processing of the voice command that corresponds to the received voice command ID (Step S4). Also, when the received voice command ID is the voice command ID of a voice command for executing processing in the web app 100b, the AR middle 100a outputs the voice command ID or the corresponding voice command to the web app 100b (Step S5). Also, when a screen transition occurs in the web app 100b, the AR middle 100a transmits the screen ID of a screen after the transition to the HMD 10 (Step S6). When the HMD 10 receives the screen ID, the HMD 10 starts filtering in voice recognition, based on the filtering information that corresponds to the screen ID.

Next, a configuration of the HMD 10 will be described. As illustrated in FIG. 1, the HMD 10 includes a communication section 11, an input section 12, a display section 13, a storage section 14, and a control section 16. Note that the HMD 10 may include, in addition to the function sections illustrated in FIG. 1, for example, a function section, such as various types of input devices, voice output devices, or the like.

The communication section 11 is realized by, for example, a communication module, such as a wireless LAN or the like, or the like. The communication section 11 is a communication interface that is wirelessly coupled to the terminal device 100, for example, via Wi-Fi Direct (registered trademark), and conducts communication of information with the terminal device 100. The communication section 11 receives filtering information, end information, a display screen, and a screen ID from the terminal device 100. The communication section 11 outputs the filtering information, the end information, the display screen, and the display ID that have been received to the control section 16. Also, the communication section 11 transmits the voice command ID that has been input from the control section 16 to the terminal device 100.

The input section 12 is, for example, a microphone, and collects voice made by the user. As for the input section 12, each of various types of microphones, such as, for example, an electret capacitor microphone or the like, may be used as a microphone. The input section 12 outputs sound information that is collected voice to the control section 16.

The display section 13 is a display device used for displaying various types of information. The display section 13 corresponds to, for example, a display element of a transmission-type HMD in which a video image is projected on a half mirror and through which the user sees an external scene with the video image. Note that the display section 13 may be a display element that corresponds to an immersive HMD, a video see-though HMD, a retina projection HMD, or the like.

The storage section 14 is realized by, for example, a storage device, such as a semiconductor memory device, such as random access memory (RAM), flash memory, or the like. The storage section 14 includes a filtering information storage section 15. Also, the storage section 14 stores information used for processing in the control section 16.

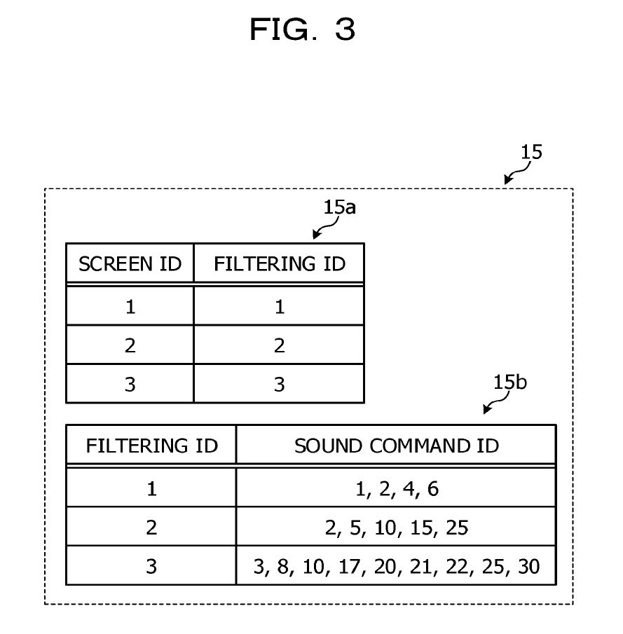

The filtering information storage section 15 stores the filtering information received from the terminal device 100. Note that the filtering information storage section 15 is an example of a voice command dictionary. FIG. 3 is a view illustrating an example of a filtering information storage section. As illustrated in FIG. 3, the filtering information storage section 15 includes a screen ID management table 15a and a voice command ID management table 15b. The screen ID management table 15a stores a screen ID and a filtering ID in association with one another. That is, the screen ID management table 15a includes items, such as “SCREEN ID” and “FILTERING ID”.

“SCREEN ID” is an identifier that identifies a screen that is displayed on the HMD 10. “FILTERING ID” is an identifier that identifies a set of voice commands in a screen that is displayed. Note that the screen ID management table 15a may use, instead of “SCREEN ID”, for example, “APP ID” that identifies the type of the web app 100b. In this case, “FILTERING ID” is an identifier that identifies a set of voice commands in the web app 100b.

The voice command ID management table 15b stores a filtering ID and a voice command ID in association with one another. That is, the voice command ID management table 15b includes items, such as “FILTERING ID” and “VOICE COMMAND ID”.

“FILTERING ID” is an identifier that identifies a set of voice commands in a screen that is displayed. “VOICE COMMAND ID” is an identifier that identifies a voice command. Also, a voice pattern (not illustrated) is associated with “VOICE COMMAND ID” and thus stored.

Returning to the description of FIG. 1, the control section 16 is realized by, for example, causing a central processing unit (CPU), a micro processing unit (MPU), or the like to execute a program stored in an internal storage device in the RAM serving as a working area. Also, the control section 16 may be realized by, for example, an integrated circuit, such as an application specific integrated circuit (ASIC), a field programmable gate array (FPGA), or the like. The control section 16 includes a display control section 17, an acquisition section 18, and a comparison section 19, and realizes or executes function or operation of information processing that will be described below. Note that an internal configuration of the control section 16 is not limited to the configuration illustrated in FIG. 1 but may be another configuration, as long as the another configuration is a configuration that performs information processing that will be described later.

For example, when power is turned on by the user and reception of a display screen is started, the display control section 17 outputs a startup instruction for stating up a voice recognition engine to the acquisition section 18. Also, the display control section 17 receives the filtering information, the display screen, and the screen ID from the terminal device 100 via the communication section 11. The display control section 17 stores the received filtering information in the filtering information storage section 15. Also, when the display control section 17 receives the display screen with which the screen ID is associated from the terminal device 100 via the communication section 11, the display control section 17 outputs the screen ID to the acquisition section 18 and also causes the display section 13 to display the display screen.

Furthermore, when a screen transition occurs for the display screen with which the screen ID is associated, the display control section 17 outputs the screen ID to the acquisition section 18 and causes the display section 13 to display the display screen also for the display screen and the screen ID after the transition in a similar manner. Note that, when the display control section 17 receives a display screen with which the screen ID is not associated, that is, for example, a display screen in a state where the web app 100b has not started up, the display control section 17 causes the display section 13 to display the received display screen.

When, during display of the display screen with which the screen ID is associated, the display screen is updated to a display screen including a voice command recognized in the display screen, the display control section 17 causes the display section 13 to display the updated display screen. That is, the display control section 17 displays, among the plurality of voice commands, a voice command that is associated with the acquired voice pattern on the display screen. Also, the display control section 17 determines whether or not the end information has been received from the terminal device 100 via the communication section 11. If the end information has not been received, the display control section 17 stands by for acquiring the sound information. If the end information has been received, the display control section 17 outputs an end instruction to the acquisition section 18.

When the startup instruction is input to the acquisition section 18 from the display control section 17, the acquisition section 18 starts up the voice recognition engine and starts acquiring sound information collected by the input section 12. The acquisition section 18 converts the acquired sound information to sound information that may be compared to the voice patterns stored in the filtering information storage section 15, using the voice recognition engine. That is, the acquisition section 18 recognizes the voice command. When the screen ID is input to the acquisition section 18 from the display control section 17, the acquisition section 18 refers to the filtering information storage section 15 and acquires one or more voice command IDs and voice patterns associated with the screen ID. The acquisition section 18 outputs the sound information after the conversion, the voice command ID, and the voice pattern to the comparison section 19. That is, the acquisition section 18 starts filtering of the acquired sound information using the filtering information. Also, when the end instruction is input to the acquisition section 18 from the display control section 17, the acquisition section 18 stops the voice recognition engine.

When the sound information after the conversion, the voice command ID, and the voice pattern are input to the comparison section 19 from the acquisition section 18, the comparison section 19 compares the sound information after the conversion and the voice pattern to one another. If the sound information after the conversion matches one of the one or more voice patterns, the comparison section 19 generates a comparison result including the voice command ID that corresponds to the matching voice pattern and indicating that the sound information after the conversion matches the voice pattern. If the sound information after the conversion does not match any of the one or more sound patterns, the comparison section 19 generates a comparison result indicating that the sound information after the conversion does not match the voice pattern. The comparison section 19 outputs the generated comparison result. That is, the comparison section 19 also serves as an output control section and transmits the generated comparison result to the terminal device 100 via the communication section 11.

In other words, the comparison section 19 determines whether or not the sound information after the conversion matches the filtering information. If the sound information after the conversion matches the filtering information, the comparison section 19 generates a comparison result including the voice command ID that corresponds to the matching voice pattern and indicating that the sound information after the conversion matches the filtering information, and transmits the generated comparison pattern to the terminal device 100. If the sound information after the conversion does not match the filtering information, the comparison section 19 generates a comparison result indicating that the sound information after the conversion does not match the filtering information and transmits the generated comparison result to the terminal device 100.

Also, if the generated comparison result is a comparison result indicating that the sound information after the conversion matches the filtering information, the comparison section 19 outputs, for example, a recognition sound to an earphone or the like (not illustrated). Furthermore, if the generated comparison result is a comparison result indicating that the sound information after the conversion does not match the filtering information, the comparison section 19 outputs, for example, voice saying “UNABLE TO RECOGNIZE” or the like to the earphone or the like (not illustrated). Note that the comparison section 19 may be configured so as not to output, if the generated comparison result is a comparison result indicating that the sound information after the conversion does not match the filtering information, a recognition sound or voice.

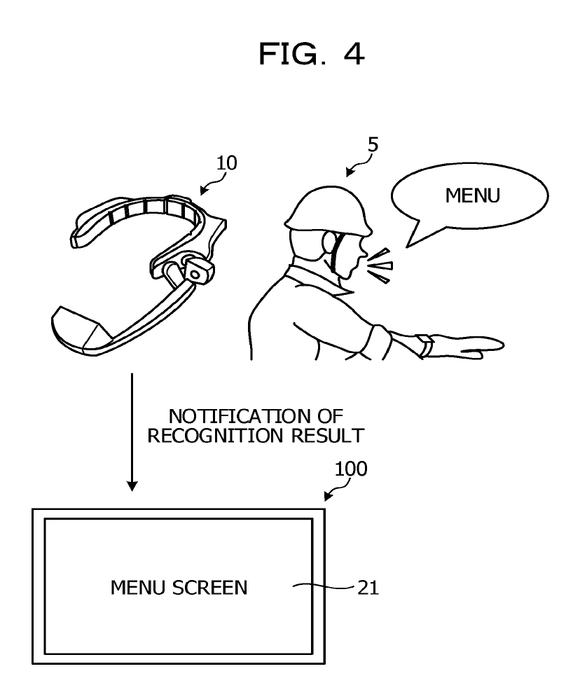

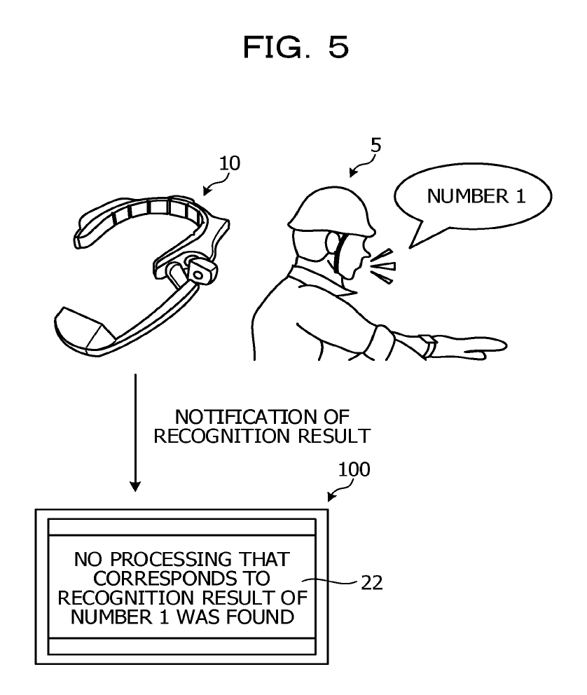

With reference to FIG. 4 and FIG. 5, examples of a display screen both in a case where there is a voice command that corresponds to a voice pattern of filtering information and a case where there is not such a voice command will be described. FIG. 4 is a view illustrating an example where there is a corresponding voice command. Note that, in each of FIG. 4 and FIG. 5, in order to describe an example, a display screen that is displayed on the display element of the HMD 10 is schematically illustrated in the terminal device 100.

As illustrated in FIG. 4, when a user 5 utters “MENU”, the HMD 10 determines whether or not the sound information of “MENU” matches the filtering information. In the example of FIG. 4, the sound information of “MENU” matches the filtering information, and therefore, the HMD 10 transmits a recognition result, that is, a comparison result, indicating that the sound information of “MENU” matches the filtering information, to the terminal device 100. The terminal device 100 transmits, based on the voice command ID included in the comparison result, a menu screen 21 to the HMD 10 to cause the HMD 10 to display the menu screen 21.

FIG. 5 is a view illustrating an example where there is not a corresponding voice. As illustrated in FIG. 5, when the user 5 utters “NUMBER 1”, the HMD 10 determines whether or not the sound information of “NUMBER 1” matches the filtering information. In the example of FIG. 5, the sound information of “NUMBER 1” does not match the filtering information, and therefore, the HMD 10 transmits a recognition result, that is, a comparison result, indicating that the sound information of “NUMBER 1” does not match the filtering information to the terminal device 100. The terminal device 100 transmits, based on the comparison result indicating that the sound information of “NUMBER 1” does not match the filtering information, an error screen 22 to the HMD 10 to cause the HMD 10 to display the error screen 22.

Subsequently, a configuration of the terminal device 100 will be described. As illustrated in FIG. 1, the terminal device 100 includes a first communication section 110, a second communication section 111, a display operation section 112, a storage section 120, and a control section 130. Note that the terminal device 100 may include, in addition to the function sections illustrated in FIG. 1, various types of function sections, such as, for example, various types of input devices, voice output devices, or the like, which are to be included in a known computer.

The first communication section 110 is realized by, for example, a communication module, such as a wireless LAN or the like, or the like. The first communication section 110 is a communication interface that is wirelessly coupled to the HMD 10 via, for example, Wi-Fi Direct (registered trademark) and conducts communication of information with the HMD 10. The first communication section 110 receives a comparison result from the HMD 10. The first communication section 110 outputs the received comparison result to the control section 130. Also, the first communication section 110 transmits the filtering information, the end information, the display screen, and the screen ID that have been input from the control section 130 to the HMD 10.

The second communication section 111 is realized by, for example, a communication module, such as a mobile phone line, such as third generation mobile communication system, a long term evolution (LTE), or the like, a wireless LAN, or the like. The second communication section 111 is a communication interface that is wirelessly coupled to the server 200 via the network N and conducts communication of information with the server 200. The second communication section 111 transmits a data acquisition instruction and a filtering information acquisition instruction that have been input from the control section 130 to the server 200 via the network N. Also, the second communication section 111 receives the AR contents that correspond to the data acquisition instruction and the filtering information that corresponds to the filtering information acquisition instruction from the server 200 via the network N. The second communication section 111 outputs the AR contents and the filtering information that have been received to the control section 130.

The display operation section 112 serves as a display device that displays various types of information and also as an input device that receives various types of operations from a user. For example, the display operation section 112 is realized as the display device by a liquid crystal display or the like. Also, for example, the display operation section 112 is realized as the input device by a touch panel or the like. That is, the display operation section 112 is an integration of the display device and the input device. The display operation section 112 outputs an operation input by the user as operation information to the control section 130. Note that the display operation section 112 may be configured to display a similar screen to the display screen that is displayed on the HMD 10, and to display a different screen from the display screen that is displayed on the HMD 10.

The storage section 120 is realized by, for example, a storage device, such as a semiconductor memory device, such as RAM, flash memory, or the like, a hard disk drive, an optical disk, or the like. The storage section 120 includes a filtering information storage section 121 and a voice command storage section 122. Also, the storage section 120 stores information that is used for processing in the control section 130.

The filtering information storage section 121 stores the filtering information acquired from the server 200. Note that the filtering information storage section 121 has a similar configuration to that of the filtering information storage section 15 of the HMD 10 and the description thereof will be omitted.

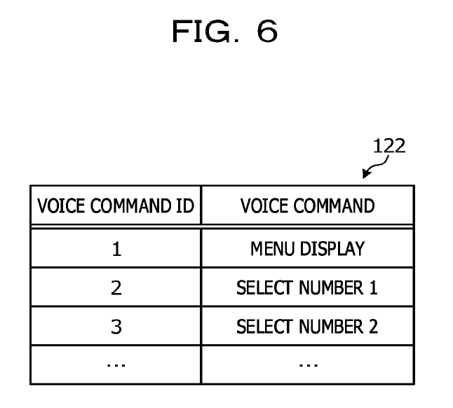

The voice command storage section 122 stores a voice command ID and a voice command in association with one another. FIG. 6 is a table illustrating an example of a voice command storage section. As illustrated in FIG. 6, the voice command storage section 122 includes items, such as “VOICE COMMAND ID” and “VOICE COMMAND”. The voice command storage section 122 stores, for example, a record for each voice command ID.

“VOICE COMMAND ID” is an identifier that identifies the voice command. “VOICE COMMAND ID” is information that indicates a command, such as, for example, “MENU DISPLAY”, “SELECT NUMBER 1”, or the like.

Returning to the description of FIG. 1, the control section 130 is realized by, for example, causing a CPU, an MPU, or the like to execute a program stored in an internal storage device in the RAM serving as a working area. Also, the control section 130 may be realized by, for example, an integrated circuit, such as an ASIC, an FPGA, or the like. The control section 130 includes an execution section 131, and realizes or executes function or operation of information processing that will be described below. Note that an internal configuration of the control section 130 is not limited to the configuration illustrated in FIG. 1 but may be another configuration, as long as the another configuration is a configuration that performs information processing that will be described later.

The execution section 131 executes an AR app, that is, the AR middle 100a and the web app 100b. For example, when the power of the terminal device 100 is turned on, the execution section 131 starts transmitting a display screen to the HMD 10. The AR middle 100a instructs, for example, based on the operation information input by the user from the display operation section 112, a startup of the web app 100b. When the filtering information is input to the AR middle 100a from the web app 100b, the AR middle 100a transmits the input filtering information to the HMD 10 via the first communication section 110. Also, the AR middle 100a transmits the display screen and the screen ID to the HMD 10 via the first communication section 110.

When the AR middle 100a receives a comparison result from the HMD 10 via the first communication section 110, the AR middle 100a executes processing in accordance with the comparison result. If the AR middle 100a receives a comparison result including the voice command ID and indicating that the sound information matches the voice pattern, the AR middle 100a refers to the voice command storage section 122 and determines whether or not the voice command that corresponds to the voice command ID is to be processed by the AR middle 100a. If the voice command is to be processed by the AR middle 100a, the AR middle 100a executes processing that corresponds to the voice command.

If the voice command is not to be processed by the AR middle 100a, the AR middle 100a outputs the voice command to the web app 100b. Note that the AR middle 100a may be configured, if the AR middle 100a receives a comparison result indicating that the sound information does not match any voice pattern, to cause a message indicating that it is unable to recognize voice to be displayed on the display screen and also not to perform any processing.

The AR middle 100a determines whether or not there is a screen transition for processing that corresponds to the voice command. If there is such a screen transition, the AR middle 100a transmits the screen ID of the display screen after the transition to the HMD 10 via the first communication section 110. If there is not such a screen transition, the AR middle 100a determines whether or not the web app 100b has ended.

If the web app 100b has not ended, the AR middle 100a stands by for receiving a comparison result from the HMD 10. If the web app 100b has ended, the AR middle 100a transmits end information to the HMD 10 via the first communication section 110.

The web app 100b starts up in accordance with a startup instruction from the AR middle 100a. When the web app 100b starts up, the web app 100b transmits a data acquisition instruction and a filtering information acquisition instruction to the server 200 via the second communication section 111 and the network N. The web app 100b acquires the AR contents that correspond to the data acquisition instruction and the filtering information that corresponds to the filtering information acquisition instruction from the server 200 via the second communication section 111 and the network N.

The web app 100b generates a display screen including the AR contents in cooperation with the AR middle 100a and transmits the generated display screen to the HMD 10 via the first communication section 110 to cause the HMD 10 to display the generated display screen. Also, the web app 100b outputs the acquired filtering information to the AR middle 100a. If the voice command is input to the web app 100b from the AR middle 100a, the web app 100b executes processing that corresponds to the voice command.

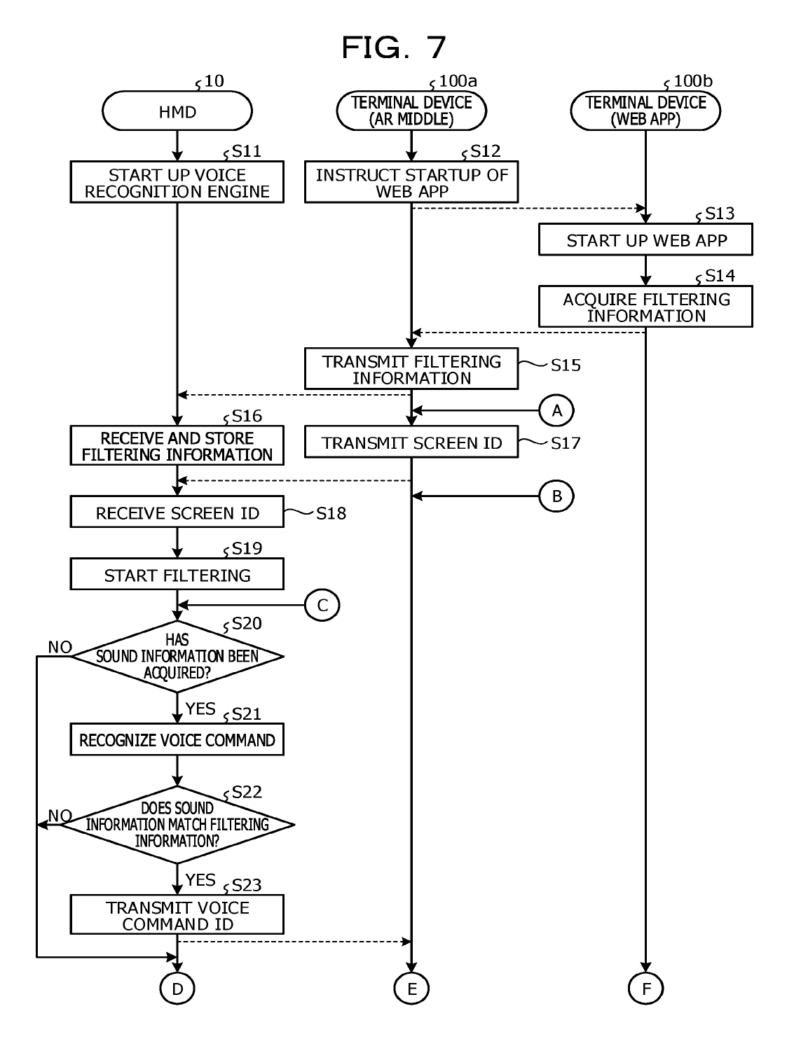

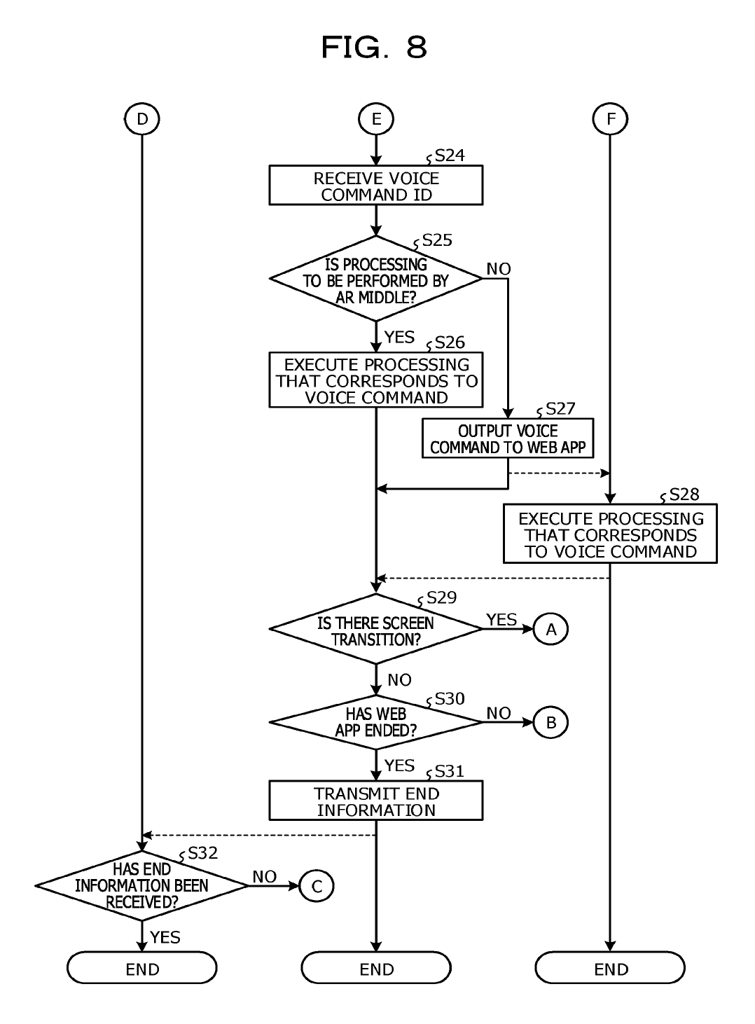

Next, an operation of the voice input support system 1 according to an embodiment will be described. Each of FIG. 7 and FIG. 8 is a sequence diagram illustrating an example of voice input processing according to an embodiment.

For example, when power is turned on by the user and reception of a display screen is started, the display control section 17 of the HMD 10 outputs a startup instruction for starting up the voice recognition engine to the acquisition section 18. When the startup instruction is input to the acquisition section 18 from the display control section 17, the acquisition section 18 starts up the voice recognition engine and starts acquiring sound information collected by the input section 12 (Step S11).

For example, when the power of the terminal device 100 is turned on, the execution section 131 of the terminal device 100 starts transmitting the display screen to the HMD 10. The AR middle 100a that is executed by the execution section 131 instructs a startup of the web app 100b, for example, based on the operation information that has been input by the user from the display operation section 112 (Step S12). The web app 100b starts up in accordance with the startup instruction from the AR middle 100a (Step S13). When the web app 100b starts up, the web app 100b transmits a data acquisition instruction and a filtering information acquisition instruction to the server 200. The web app 100b acquires the AR contents that correspond to the data acquisition instruction and the filtering information that corresponds to the filtering information acquisition instruction from the server 200 (Step S14).

If the filtering information is input to the AR middle 100a from the web app 100b, the AR middle 100a transmits the input filtering information to the HMD 10 (Step S15). When the display control section 17 of the HMD 10 receives the filtering information, the display control section 17 stores the received filtering information in the filtering information storage section 15 (Step S16)

Also, the AR middle 100a of the terminal device 100 transmits the display screen and the screen ID to the HMD 10 (Step S17). The display control section 17 of the HMD 10 receives the display screen and the screen ID from the terminal device 100 (Step S18). When the display control section 17 receives the display screen and the screen ID, the display control section 17 outputs the screen ID to the acquisition section 18 and also causes the display section 13 to display the display screen. The acquisition section 18 refers to the filtering information storage section 15 and starts filtering the acquired sound information using the filtering information (Step S19). The acquisition section 18 determines whether or not the sound information has been acquired (Step S20). If the sound information has been acquired (YES in Step S20), the acquisition section 18 converts the acquired sound information to sound information that may be compared to voice patterns stored in the filtering information storage section 15, using the voice recognition engine. That is, the acquisition section 18 recognizes the voice command (Step S21). If the sound information has not been acquired (NO in Step S20), the acquisition section 18 causes the process to proceed to Step S32.

When the screen ID is input to the acquisition section 18 from the display control section 17, the acquisition section 18 refers to the filtering information storage section 15 and acquires one or more voice command IDs and voice patterns associated with the screen ID. The acquisition section 18 outputs the sound information after the conversion, the voice command ID, and the voice pattern to the comparison section 19. When the sound information after the conversion, the voice command ID, and the voice pattern are input to the comparison section 19 from the acquisition section 18, the comparison section 19 determines whether or not the sound information after the conversion matches the voice pattern, that is, the filtering information (Step S22).

If the sound information after the conversion matches the filtering information (YES in Step S22), the comparison section 19 transmits a comparison result including the voice command ID that corresponds to the matching voice pattern and indicating that the sound information after the conversion matches the filtering information to the terminal device 100 (Step S23). If the sound information after the conversion does not match the filtering information (NO in Step S22), the comparison section 19 transmits a comparison result indicating that the sound information after the conversion does not match the filtering information to the terminal device 100 and causes the process to proceed to Step S32.

The AR middle 100a of the terminal device 100 receives the comparison result including the voice command ID and indicating that the sound information after the conversion matches the filtering information from the HMD 10 (Step S24). When the AR middle 100a receives the comparison result including the voice command ID and indicating that the sound information after the conversion matches the filtering information, the AR middle 100a refers to the voice command storage section 122 and determines whether or not the voice command that corresponds to the voice command ID is to be processed by the AR middle 100a (Step S25). If the voice command that corresponds to the voice command ID is to be processed by the AR middle 100a (YES in Step S25), the AR middle 100a executes processing that corresponds to the voice command (Step S26).

If the voice command that corresponds to the voice command ID is not to be processed by the AR middle 100a (NO in Step S25), the AR middle 100a outputs the voice command to the web app 100b (Step S27). When the voice command is input to the web app 100b from the AR middle 100a, the web app 100b executes processing that corresponds to the voice command (Step S28).

The AR middle 100a determines whether or not there is a screen transition for processing that corresponds to the voice command (Step S29). If there is a screen transition (YES in Step S29), the AR middle 100a causes the process to return to Step S17 and transmits the screen ID of the display screen after the transition to the HMD 10. If there is not a screen transition (NO in Step S29), the AR middle 100a determines whether or not the web app 100b has ended (Step S30).

If the web app 100b has not ended (NO in Step S30), the AR middle 100a causes the process to return to Step S24 and stands by for receiving a comparison result from the HMD 10. If the web app 100b has ended (YES in Step S30), the AR middle 100a transmits the end information to the HMD 10 (Step S31).

The display control section 17 of the HMD 10 determines whether or not the HMD 10 has received the end information from the terminal device 100 (Step S32). If the HMD 10 has not received the end information (NO in Step S32), the display control section 17 causes the process to return to Step S20. If the HMD 10 has received the end information (YES in Step S32), the display control section 17 outputs an end instruction to the acquisition section 18. When the end instruction is input to the acquisition section 18 from the display control section 17, the acquisition section 18 stops the voice recognition engine to end voice input processing. Thus, the HMD 10 and the terminal device 100 may increase voice recognition accuracy.

Note that in the above-described embodiments, in the filtering information storage section 15, the screen ID management table 15a in which the screen ID and the filtering ID are associated with one another is used, but the filtering information storage section 15 is not limited thereto. For example, an app ID management table using, instead of “SCREEN ID”, “APP ID” that identifies the type of the web app 100b may be used.

Thus, when the HMD 10 acquires the sound information collected by the microphone, the HMD 10 refers to the storage section 14 that stores a plurality of voice patterns in association with image information and acquires a voice pattern associated with the image information displayed on the screen of a terminal. Also, the HMD 10 compares the acquired sound information and the acquired voice pattern to one another and outputs a comparison result. As a result, voice recognition accuracy may be increased.

Also, when the HMD 10 acquires the sound information collected by the microphone, the HMD 10 refers to the storage section 14 that stores each of the plurality of voice patterns in association with the corresponding app type and acquires the voice pattern associated with the app type displayed on the screen of the terminal. Also, the HMD 10 compares the acquired sound information and the acquired voice pattern to one another and outputs a comparison result. As a result, voice recognition accuracy may be increased.

The HMD 10 and the terminal device 100 further refer to the storage section 120 that stores each of the plurality of voice commands in association with the corresponding voice pattern and display a voice command, among the plurality of voice commands, which is associated with the acquired voice pattern, on the screen of the terminal. As a result, the user is able to check the input voice command.

The HMD 10 acquires the plurality of voice patterns and the image information or the plurality of voice patterns and the app type from the terminal device 100 and stores the plurality of voice patterns and the image information or the plurality of voice patterns and the app type in the storage section 14. As a result, a result of voice recognition may be filtered in accordance with the image information or the app type.

The HMD 10 includes a microphone, a display, and a storage section 14 that stores a voice pattern in association with each of pieces of image information which is displayed on the display. Also, the HMD 10 includes a control section that, when sound information collected by the microphone is acquired, refers to the storage section 14, acquires a voice pattern associated with the image information displayed on the display, and outputs a result of comparison between the acquired sound information and the acquired voice pattern. As a result, voice recognition accuracy may be increased.

Note that, in the above-described embodiments, the terminal device 100 and the HMD 10 have been described as a terminal device and a HMD that are worn by a user, but are not limited thereto. For example, sound recognition may be performed by the terminal device 100, which is, for example, a smartphone, without using the HMD 10.

Each component element of each section illustrated in the drawings may not be physically configured as illustrated in the drawings. That is, specific embodiments of disintegration and integration of each section are not limited to those illustrated in the drawings, and all or some of the sections may be disintegrated/integrated functionally or physically in an arbitrary unit in accordance with various loads, use conditions, and the like. For example, the acquisition section 18 and the comparison section 19 may be integrated. Also, the order of the respective steps illustrated in the drawings is not limited to the above-described order and, to the extent that there is no contradiction, the respective steps may be simultaneously performed and also may be performed in a different order.

Furthermore, the whole or a part of each processing function performed by each unit may be executed on a CPU (or a microcomputer, such as an MPU, a micro control unit (MCU), or the like). Needless to say, the whole or a part of each processing function may be executed on a program that is analyzed and executed by a CPU (or a microcomputer, such as an MPU, an MCU, or the like) or a hardware of a wired logic.

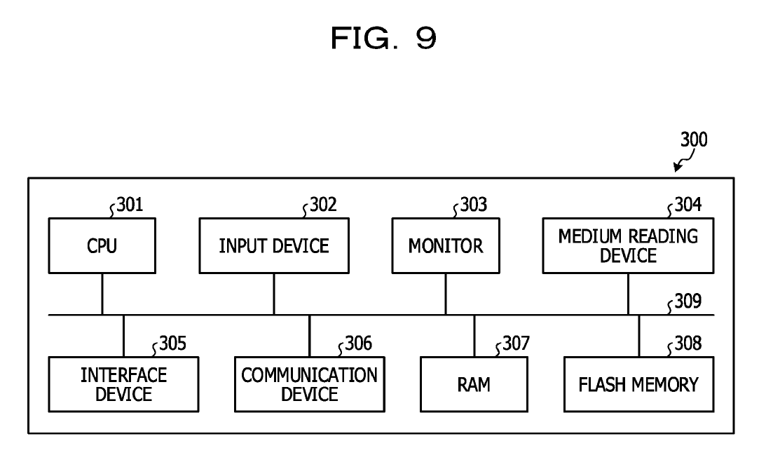

Incidentally, various types of processing described in the above-described embodiments may be realized by causing a computer to execute a program prepared in advance. Therefore, an example of a computer that executes a program having similar functions to those described in the above-described embodiments will be described below. FIG. 9 is a diagram illustrating an example of a computer that executes a voice input support program.

As illustrated in FIG. 9, a computer 300 includes a CPU 301 that executes various types of arithmetic processing, an input device 302 that receives data input, and a monitor 303. Also, the computer 300 includes a medium reading device 304 that reads a program or the like from a storage medium, an interface device 305 that provides a connection to each of various units, and a communication device 306 that provides a wired or wireless connection to another information processing device or the like. Also, the computer 300 also includes RAM 307 that temporarily stores various types of information and flash memory 308. Each of the units 301 to 308 is coupled to a bus 309.

A voice input support program having a similar function to that of each of the processing sections of the display control section 17, the acquisition section 18, and the comparison section 19 illustrated in FIG. 1 is stored in the flash memory 308. Also, various types of data used for realizing the filtering information storage section 15 and the voice input support program are stored in the flash memory 308. The input device 302 receives, for example, an input of sound information, such as voice or the like, from a user of the computer 300. The monitor 303 displays, for example, various types of screens, such as a display screen or the like, to the user of the computer 300. For example, a headphone or the like is coupled to the interface device 305. The communication device 306, for example, has a similar function to that of the communication section 11 illustrated in FIG. 1, is coupled to the terminal device 100, and exchanges various types of information with the terminal device 100.

The CPU 301 reads each of programs stored in the flash memory 308, expands the program in the RAM 307, and then, executes the program, thereby performing various types of processing. The programs may cause the computer 300 to function as the display control section 17, the acquisition section 18, and the comparison section 19 illustrated in FIG. 1.

Note that there may be a case where the above-described voice input support program is not stored in the flash memory 308. For example, a configuration in which the computer 300 reads a program stored in a computer readable storage medium from which the computer 300 may read data and execute the program may be employed. For example, a portable recording medium, such as CD-ROM, a DVD disk, universal serial bus (USB) memory, or the like, a semiconductor memory, such as flash memory or the like, a hard disk drive, or the like corresponds to the computer readable storage medium from which the computer 300 may read data. As another option, a configuration in which the voice input support program is stored in a unit coupled to a public line, the Internet, a LAN, or the like in advance and the computer 300 is configured to read the voice input support program from the unit to execute the voice input support program may be employed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
circuitry configured to:
acquire information identifying a plurality of voice commands associated with each of a plurality of screens to be displayed by a display,
identify a first plurality of voice commands of the plurality of voice commands corresponding to a first screen, of the plurality of screens, currently displayed by the display,
acquire first sound information captured by a microphone,
compare the first sound information to first voice patterns associated with the first plurality of voice commands, and
output a first result based on a first comparison between the first sound information to the first voice patterns.

2. The information processing system according to claim 1, wherein the circuitry is configured to:
determine that the first sound information corresponds to a command to switch the display from displaying the first screen to displaying a second screen of the plurality of screens based on the comparison, and
cause the display to switch from displaying the first screen to displaying the second screen based on a result of determining.

3. The information processing system according to claim 2, wherein the circuitry is configured to:
acquire second sound information captured by the microphone,
identify a second plurality of voice commands of the plurality of voice commands corresponding to the second screen,
compare the second sound information to second voice patterns associated with the second plurality of voice commands, and
output a second result based on a second comparison between the second sound information to the second voice patterns.

4. The information processing system according to claim 3, wherein
the second plurality of voice commands includes a different set of voice commands from a set of voice commands included in the first plurality of voice commands.

5. The information processing system according to claim 1, wherein
the circuitry is configured to cause the display to display an indication that the first sound information does not correspond to a valid voice command when the first result indicates that the first sound information does not match any of the first voice patterns associated with the first plurality of voice commands.

6. The information processing system according to claim 1, wherein
the circuitry is configured to cause a speaker to output an audible notification that the first sound information corresponds to a valid voice command when the first result indicates that the first sound information matches one of the first voice patterns associated with the first plurality of voice commands.

7. The information processing system according to claim 1, further comprising:
a communication interface configured to acquire the information identifying the plurality of voice commands associated with each of the plurality of screens from a device communicatively coupled to the information processing system.

8. The information processing system according to claim 1, further comprising:
a communication interface configured to output the first result to a terminal device communicatively coupled to the information processing system.

9. The information processing system according to claim 8, wherein
the first result identifies a specific voice command of the first plurality of voice commands identified by determining that the first sound information matches a voice pattern associated with the specific voice command.

10. The information processing system according to claim 1, further comprising:
a communication interface; and
a terminal device communicatively coupled to the communication interface, wherein
the circuitry is configured to control the communication interface to output an identification of a specific voice command of the first plurality of voice commands identified by determining that the first sound information matches a voice pattern associated with the specific voice command.

11. The information processing system according to claim 10, wherein
the terminal device includes the display and is configured to switch the display from displaying the first screen to displaying a second screen of the plurality of screens based on the received identification of the specific voice command.

12. The information processing system according to claim 10, wherein
the terminal device is configured to determine whether processing corresponding to the specific voice command is to be performed locally at the terminal device or by a server communicatively coupled to the terminal device via a network.

13. The information processing system according to claim 12, wherein
the terminal device is configured to transmit information identifying the specific voice command to the server when it is determined that the specific voice command is to be processed by the server.

14. The information processing system according to claim 12, wherein the terminal device is configured to locally process the specific voice command when it is determined that the specific voice command is to be locally processed by the terminal.

15. The information processing system according to claim 1, wherein
the terminal device includes the display.

16. The information processing system according to claim 1, wherein
the information processing system is a head-mounted display (HMD) device.

17. The information processing system according to claim 1, further comprising:
the microphone configured to capture the first sound information.

18. The information processing system according to claim 1, further comprising:
the display configured to display each of the plurality of screens.

19. A method performed by an information processing system, the method comprising:
acquiring information identifying a plurality of voice commands associated with each of a plurality of screens to be displayed by a display;
identifying a first plurality of voice commands of the plurality of voice commands corresponding to a first screen, of the plurality of screens, currently displayed by the display;
acquiring first sound information captured by a microphone;
comparing the first sound information to first voice patterns associated with the first plurality of voice commands; and
outputting a first result based on a first comparison between the first sound information to the first voice patterns.

20. A device comprising:
a communication interface configured to receive information identifying a plurality of voice commands associated with each of a plurality of screens to be displayed by a display;
circuitry configured to identify a first plurality of voice commands of the plurality of voice commands corresponding to a first screen, of the plurality of screens, currently displayed by the display; and
a microphone configured to acquire sound information captured by a microphone, wherein
the circuitry is configured to
compare the sound information to voice patterns associated with the first plurality of voice commands;
determine that the sound information corresponds to a specific voice command of the plurality of voice commands; and
cause the display to change from displaying the first screen to a second screen based on the specific voice command.
